(19) United States
(12) Patent Application Publication
(10) Pub. No.: US 2009/0075038 A1
(43) Pub. Date: Mar. 19, 2009

(54) Printing formulations

(75) Inventors: Michael Francis Butler, Sharnbrook (GB); John William Davison, Bordon (GB); Ramin Djalali, Sharnbrook (GB); Philip Michael Parkins, Bordon (GB)

Correspondence Address: UNILEVER PATENT GROUP, 800 SYLVAN AVENUE, AG West S. Wing, ENGLEWOOD CLIFFS, NJ, 07632-3100, US

(73) Assignee: Conopco, Inc. d/b/a Unilever

(21) Appl. No.: 12/229,846

(22) Filed: Aug. 27, 2008

(30) Foreign Application Priority Data
Aug. 31, 2007 (EP) EP07115381

(51) Int. Cl. B32B 3/10; C09D 7/00; C09D 121/02; C09D 109/00; C09D 133/00; C09D 133/08; C09D 133/18; C09D 133/24; C09D 133/26

(52) U.S. Cl. 428/196; 428/195.1; 428/210; 428/211.1; 106/31.01; 524/501; 524/556; 524/563; 524/565; 524/571; 524/590; 524/548

(57) ABSTRACT

The present invention relates to a printing formulation comprising monodisperse particles and particles, wherein the particles have a largest dimension which is at least 6 times larger than the largest dimension of the monodisperse particles, as well as to the use of these formulations for printing and to substances printed with these formulations.

The present invention relates to a printing formulation comprising monodisperse particles and particles, wherein the particles have a largest dimension which is at least 6 times larger than the largest dimension of the monodisperse particles, as well as to the use of these formulations for printing and to substances printed with these formulations.

Formulations for the inkjet technology comprising monodisperse particles are for example known from WO2005/063902.

There is a constant need for improved inks.

Therefore, the goal of the present patent application was to provide a formulation for a printing process, which allows an excellent printing quality.

Surprisingly, it has been found out that the use of a formulation comprising monodisperse particles and particles, which have a largest dimension which is at least 6 times larger than the largest dimension of the monodisperse particles leads to printings, wherein the monodisperse particles are arrange fast in a very good manner.

In a first aspect, the present invention provides a printing formulation (PF I) comprising
(i) monodisperse particles, and
(ii) particles, which have a largest dimension which is at least 6 times larger than the largest dimension of the monodisperse particles.

The monodisperse particles according to the present invention are capable of forming a colloidal crystal that diffracts light having a wavelength in a range that corresponds to the wavelength of visible light.

By the term “monodisperse particles” it is meant that all these particles in a formulation have the same size (diameter). A more comprehensive definition is given below.

Processes for applying the formulation according to the present invention are commonly known process and they will be discussed below.

In a formulation according to the present invention the amount of monodisperse particles capable of forming a colloidal crystal that diffracts light having a wavelength in a range that corresponds to the wavelength of visible light can vary a lot Depending whether the formulation is used as a concentrate which is to be diluted (with water and/or other solvents) or as a ready-to-use formulation. In the first case the amount of monodisperse particles is large, up to 70 weight-% (wt-%), based on the total weight of the printing formulation.

The amount of monodisperse particles in printing formulations according to the present invention can go from 0.01 to 70 wt-%.

In ready to use printing formulation the amount of the monodisperse particles can vary from 0.01 up to 30 wt-%, based on the total weight of the printing formulation.

It is obvious that the amount of the monodisperse particles also depend on the substrate which is to be printed as well as on the hue which needs to be obtained.

The present invention also relates to a concentrated printing formulation, wherein the amount of monodisperse particles lies between 30 wt-% and 70 wt-%, preferably between 30 wt-% and 60 wt-%, more preferably between 30 wt-% and 55 wt-%, based on the total weight of the printing formulation.

The present invention also relates to a printing formulation, wherein the amount of monodisperse particles lies between 0.01 wt-% and 30 wt-%, between 0.1 and 30 wt-%, more preferably between 0.1 and 20 wt-%, based on the total weight of the printing formulation.

It also to be stated that the amount of monodisperse particles can vary depending of the physical form of the formulation, that means the concentration can vary in case that the formulation is in liquid, gel, wax or paste form.

Monodisperse particles are defined as having at least 60% of the particles fall within a specified particle size range.

Preferred are monodisperse particles which are spherical. Therefore the largest dimension is the diameter of such a sphere.

Monodispersed particles deviate less than 10% in root mean square (rms) diameter. Highly monodisperse particles deviate less than 5% in rms diameter. Monodisperse particles for use in the invention typically have an rms diameter of less than about 1 μm and greater than about 1 nm, and are therefore classed as nanoparticles. Preferably the monodisperse particles have an rms diameter of greater than about 150 or about 200 nm. Preferably the monodisperse particles have an rms diameter of less than about 900 nm or about 800 nm. That means a usual diameter goes from 150 nm to 900 nm, preferably from 150 nm to 800 nm. More preferably the diameter of the monodisperse particles is from about 200 nm to about 550 nm.

The monodisperse particles are chosen such that they can form a colloidal crystal which appears coloured to the human eye, i.e. in the visible spectrum. The crystal colour or colours observed depend principally on two factors, namely the lattice spacing within the colloidal crystal and the refractive index of the particles and matrix, which affects the wavelength of light diffracted. The lattice spacing is determined by factors such as the size of the monodisperse particle. For example, we have used particles having a diameter of from 250 to 510 nm to generate coloured colloidal crystals having colours ranging from blue and red to green and yellow. Colloidal crystals can have different colours when viewed from different angles because the lattice spacing can be different in different axes of the crystal. Provided that the lattice spacing in at least one axis results in diffraction of light with a wavelength in the visible spectrum then the crystal will appear to be coloured.

Monodisperse particles can be of varying geometry. In a preferred embodiment, the monodisperse particles are substantially spherical.

In another preferred embodiment of the present invention the monodisperse particles are spherical.

In another preferred embodiment of the present invention the monodisperse particles are inorganic.

In another preferred embodiment of the present invention the monodisperse particles are organic polymers.

Preferably, the lattice spacing in at least one axis is from about 350 to about 780 nm, preferably from 380 to 770 nm.

The monodisperse particles suitable for use in the colorant compositions of the present invention may be made from any suitable material, including one or more selected from organic and/or inorganic materials. For example, suitable organic materials include organic polymer particles such as latex, acrylic, polystyrene, poly(vinyl acetate), polyacrylonitrile, poly(styrene-co-butadiene), polyester, polyamides, polyurethane, poly(methylmethacrylate) and poly(fluoromethylmethacrylate) particles. Suitable inorganic materials include metal chalcogenide, metal pnictide, silica, metal and metal oxide particles. Examples of suitable metal oxides include, for example, Al₂O₃, TiO₂, SnO₂, Sb₂O₅, Fe₂O₃, ZrO₂, CeO₂ and Y₂O₃. Examples of suitable metals include, for example, gold, copper and silver.

By the term “metal chalcogenide” we mean metal compounds formed with anions from group 16 of the Periodic Table of Elements (according to established IUPAC nomenclature), i.e. oxygen, sulphur, selenium, tellurium and polonium.

By the term “metal pnictide” we mean metal compounds formed with anions from group 15 of the Periodic Table of Elements (according to established IUPAC nomenclature), i.e. nitrogen, phosphorus, arsenic, antimony and bismuth.

Monodispersed poly(methylmethacrylate) composites may be prepared following the process described by M. Egen, R. Zentel (Macromol. Chem. Phys. 2004, 205, 1479-1488) or are commercially available from Duke Scientific Corporation.

Methods for preparing monodisperse particles are known in the art. Dispersions may be prepared using emulsion, dispersion, suspension polymerization if particles are polymeric, or if particles are inorganic (e.g., silica particles) the dispersion may be prepared using sol-gel processes.

Monodispersed silica spheres can be prepared following the well-known process by Stöber, Fink and Bohn (J. Colloid Interface Sci. 1968, 26, 62). The process was later refined by Bogush, et. al. (J. Non-Crys. Solids 1988, 104, 95). Alternatively, silica particles can be purchased from Blue Helix, Limited or they can be freshly prepared by the process described in U.S. Pat. No. 4,775,520 and U.S. Pat. No. 4,911,903.

For example, monodisperse silica spheres can be produced by hydrolytic polycondensation of tetraalkoxysilanes in an aqueous-ammoniacal medium, a sol of primary particles being produced first of all and then the silica particles obtained being brought to the desired particle size by continuous, controlled addition of tetraalkoxysilane. With this process it is possible to produce monodisperse SiO₂ spheres having average particle diameters of between 0.05 and 10 μm with a standard deviation of less than 7%.

The formulations according to the present invention comprise monodisperse particles capable of forming a colloidal crystal, for example upon application of the colorant composition to a substrate. For the avoidance of doubt, references herein to “a colloidal crystal” are intended to relate to one or more colloidal crystals.

By the term “colloidal crystal” we mean a regular array of monodisperse particles having a substantially regular or constant spacing there between. Thus, the array of monodisperse particles forms a dispersed phase arranged in a continuous phase (or matrix). The continuous phase (or matrix) may comprise a gas, a liquid or a solid of a different refractive index to the dispersed phase.

As the skilled person would appreciate, a colloidal crystal may, however, contain some impurities and/or defects. The levels of impurities and/or defects typically will depend on the materials and methods of preparation used.

The term “colloidal crystal” has the same meaning as the term “super-lattice”. A colloidal crystal or super-lattice is a type of photonic crystal, which is an optical, artificial structure characterised by 2D or 3D periodic arrangements of dielectric material which lead to the formation of energy band structures for electromagnetic waves propagating them.

Preferably the colloidal crystal has a lattice spacing in a range that corresponds to the wavelength of visible light.

In a preferred embodiment the colloidal crystal has a lattice spacing in a range that corresponds to the wavelength of visible light.

The present invention also relates to a printing formulation

(PF II) comprising
(i) monodisperse particles, chosen from the group consisting of organic polymer particles such as latex, acrylic, polystyrene, poly(vinyl acetate), polyacrylonitrile, poly(styrene-co-butadiene), polyester, polyamides, polyurethane, poly(methylmethacrylate) and poly(fluoromethylmethacrylate) particles;
   inorganic materials such as metal chalcogenide, metal pnictide, silica, metal (such as gold, copper and silver) and metal oxide particles (such as Al₂O₃, TiO₂, SnO₂, Sb₂O₅, Fe₂O₃, ZrO₂, CeO₂ and Y₂O₃), and
(ii) particles, which have a largest dimension which is at least 6 times larger than the largest dimension of the monodisperse particles.

The monodisperse particles of printing formulations (PFI) and (PFII) deviate less than 10% in root mean square (rms) diameter, preferably less than 5% in rms diameter and they have a diameter from 150 nm to 900 nm, preferably from 150 nm to 800 nm, more preferably the diameter of the monodisperse particles is from about 200 nm to about 550 nm.

Suitable monodisperse particles are described for example in WO2007/057146, WO2006/097332, WO2005/063902, US2003/0125416 and WO01/88044. These patent applications are incorporated herein by reference.

The formulations according to the present invention further comprise particles, which have a largest dimension which is at least 6 times larger than the largest dimension of the monodisperse particles. Preferred are particles with a largest dimension, which is at least 6 times to 100 times larger than the largest dimension of the monodisperse particles.

More preferably the largest dimension is at least 10 times larger that the largest dimension of the monodisperse particles.

The particles should not be larger than 50 μm.

It also preferred that the particles, wherein the particles have a largest dimension which is at least 6 times larger than the largest dimension of the monodisperse particles, are substantially spherical.

The particles preferably need not to have the same size. That means it is not essential that the particles are monodisperse.

The (large) particles can be made from the same material as the monodisperse particles, but also from material such as glass (available as Spheriglass® from Omya or Potters Glass), marble, waxes (like carnuba wax), mica, calcium carbonate and talc.

It is preferred that the particles have a refraction index of around 1.5.

The particles can be solid as well as hollow.

An important feature of the particles is that they have the same surface net charge than the monodisperse particles.

The present invention also relates to a printing formulation

(PF III) comprising
(i) monodisperse particles, chosen from the group consisting of organic polymer particles such as latex, acrylic, polystyrene, poly(vinyl acetate), polyacrylonitrile, poly(styrene-co-butadiene), polyester, polyamides, polyurethane, poly(methylmethacrylate) and poly(fluoromethylmethacrylate) particles;
   inorganic materials such as metal chalcogenide, metal pnictide, silica, metal (such as gold, copper and silver) and metal oxide particles (such as Al₂O₃, TiO₂, SnO₂, Sb₂O₅, Fe₂O₃, ZrO₂, CeO₂ and Y₂O₃), and
(ii) particles, chosen from the group consisting of organic polymer particles such as latex, acrylic, polystyrene, poly(vinyl acetate), polyacrylonitrile, poly(styrene-co-butadiene), polyester, polyamides, polyurethane, poly(methylmethacrylate) and poly(fluoromethylmethacrylate) particles;
   inorganic materials such as metal chalcogenide, metal pnictide, silica, metal (such as gold, copper and silver), metal oxide particles (such as Al₂O₃, TiO₂, SnO₂, Sb₂O₅, Fe₂O₃, ZrO₂, CeO₂ and Y₂O₃), as well as glass, marble, waxes (like carnuba wax), mica, calcium carbonate and talc, which have a largest dimension which is at least 6 times larger than the largest dimension of the monodisperse particles.

The monodisperse particles of printing formulation (PF III) deviate less than 10% in root mean square (rms) diameter, preferably less than 5% in rms diameter and they have a diameter from 150 nm to 900 nm, preferably from 150 nm to 800 nm, more preferably the diameter of the monodisperse particles is from about 200 nm to about 550 nm.

The formulation according to the present invention comprises at least 0.001 wt-% of particles, wherein the particles have a largest dimension which is at least 6 times larger than the largest dimension of the monodisperse particles, based on the total weight of the formulation.

A formulation according to the present invention comprises not more that 6 wt-%, based on the total weight, of the particles.

A preferred embodiment is a formulation, wherein the monodisperse particles are present in an amount which is at least 1000 times higher, more preferred more than 10,000, than the amount of the particles. That means on 1 particle comes at least more than 1000 monodisperse particles.

Therefore an embodiment of the present invention relates to a printing formulation (PF IV) comprising
(i) 0.01-70 wt-%, based on the total weight of the printing formulation, of monodisperse particles, and
(ii) 0.001-6 wt-%, based on the total weight of the printing formulation, of particles, wherein the particles have a largest dimension which is at least 6 times larger than the largest dimension of the monodisperse particles.

The monodisperse particles of printing formulation (PF IV) deviate less than 10% in root mean square (rms) diameter, preferably less than 5% in rms diameter and they have a diameter from 150 nm to 900 nm, preferably from 150 nm to 800 nm, more preferably the diameter of the monodisperse particles is from about 200 nm to about 550 nm.

The printing formulation according to the present invention comprises at least one solvent.

Preferably the solvent is an organic solvent, which can be polar or nonpolar. Examples of polar solvents include water, alcohols (mono or poly), esters, ketones and ethers, particularly mono- and di-alkyl ethers of glycols and polyglycols such as monomethyl ethers of mono-, di and ti-propylene glycols and the mono-n-butyl ethers of ethylene, diethylene and triethylene glycols.

Examples of nonpolar solvents include aliphatic and aromatic hydrocarbons having at least six carbon atoms and mixtures thereof including refinery distillation products and by-products.

The printing formulation can be prepared as an aqueous or as a nonaqueous solution.

Therefore, another embodiment of the present invention relates to a printing formulation as described above, wherein the formulation is nonaqueous.

Therefore, another embodiment of the present invention relates to a printing formulation as described above, wherein the formulation is aqueous.

A further embodiment of the present invention relates to a printing formulation (PF V) comprising
(i) monodisperse particles, and
(ii) particles, wherein the particles have a largest dimension which is at least 6 times larger than the largest dimension of the monodisperse particles, and
(iiia) water, and
(iiib) optionally at least one solvent, chosen from the group consisting of alcohols, esters, ketones, ethers and aliphatic and aromatic hydrocarbons having at least six carbon atoms and mixtures thereof including refinery distillation products and by-products.

Therefore, the present invention also relates to a printing formulation (PF VI) comprising
(i) monodisperse particles, and
(ii) particles, wherein the particles have a largest dimension which is at least 6 times larger than the largest dimension of the monodisperse particles, and
(iii) at least one solvent, chosen from the group consisting of alcohols, esters, ketones, ethers and aliphatic and aromatic hydrocarbons having at least six carbon atoms and mixtures thereof including refinery distillation products and by-products.

The monodisperse particles of printing formulations (PF V) and (PF VI) deviate less than 10% in root mean square (rms) diameter, preferably less than 5% in rms diameter and they have a diameter from 150 nm to 900 nm, preferably from 150 nm to 800 nm, more preferably the diameter of the monodisperse particles is from about 200 nm to about 550 nm.

But, even when no water is deliberately added to the nonaqueous composition, some adventitious water may be carried into the composition, but generally this will be no more than about 2 wt-%-4 wt-%, based on the total weight of printing formulation. By definition, the nonaqueous composition of this invention will have no more than about 10 wt-%, and preferably no more than about 5 wt-% water based on the total weight of printing formulation.

The amount of solvent in a printing formulation according to the present invention is typically in the range of about 10 wt-% to about 99.99 wt-%, preferably from about 20 wt-% to about 99.9 wt-%, and more preferably from about 30 wt-% to about 99.9 wt-%, based on total weight of the printing formulation.

The amount of solvent, which is part of the inventive formulation, can very a lot. The reasons for that are the same as explained for the monodisperse particles above.

When the printing formulation is used as a concentrate, which is to be diluted (with water and/or other solvents), then the amount of solvents is low, usually between 30 wt-% and 70 wt-%, based on the total weight of the printing formulation. In certain cases the printing formulation can comprise even less that 30 wt-%.

When the formulation is in a ready-to-use form then the solvent content can be up to 99.5 wt-%, based on the total weight of the printing formulation.

It is obvious that the amount of solvent also depends on the substrate which is to be coated or printed as well as on the hue which needs to be obtained.

Therefore, the present invention also relates to a concentrated printing formulation, wherein the amount of solvent lies between 30 wt-% and 70 wt-%, preferably between 40 wt-% and 70 wt-%, more preferably between 50 wt-% and 70 wt-%, based on the total weight of printing formulation.

The present invention also relates to a printing formulation, wherein the amount of water lies between 70 wt-% and 99.99 wt-%, preferably between 70 wt-% and 99.9 wt-%, more preferably between 80 wt-% and 99.9 wt-%, based on the total weight of the printing formulation.

A further embodiment of the present invention relates to a printing formulation (PF VII) comprising
(i) 0.01 wt-% to 70 wt-%, based on the total weight of the printing formulation, of monodisperse particles, chosen from the group consisting of organic polymer particles such as latex, acrylic, polystyrene, poly(vinyl acetate), polyacrylonitrile, poly(styrene-co-butadiene), polyester, polyamides, polyurethane, poly(methylmethacrylate) and poly(fluoromethylmethacrylate) particles;
   inorganic materials such as metal chalcogenide, metal pnictide, silica, metal (such as gold, copper and silver) and metal oxide particles (such as Al₂O₃, TiO₂, SnO₂, Sb₂O₅, Fe₂O₃, ZrO₂, CeO₂ and Y₂O₃), and
(ii) 0.001 wt-% to 6 wt-%, based on the total weight of the printing formulation of particles, chosen from the group consisting of organic polymer particles such as latex, acrylic, polystyrene, poly(vinyl acetate), polyacrylonitrile, poly(styrene-co-butadiene), polyester, polyamides, polyurethane, poly(methylmethacrylate) and poly(fluoromethylmethacrylate) particles;
   inorganic materials such as metal chalcogenide, metal pnictide, silica, metal (such as gold, copper and silver), metal oxide particles (such as Al₂O₃, TiO₂, SnO₂, Sb₂O₅, Fe₂O₃, ZrO₂, CeO₂ and Y₂O₃), as well as glass, marble, waxes (like carnuba wax), mica, calcium carbonate and talc, which have a largest dimension which is at least 6 times larger than the largest dimension of the monodisperse particles, and
(iiia) 30 wt-% and 99.99 wt-%, based on the total weight of the printing formulation, of water, and
(iiib) optionally 0.1 wt-% and 89.99 wt-%, based on the total weight of the printing formulation of at least one solvent, chosen from the group consisting of alcohols, esters, ketones, ethers and aliphatic and aromatic hydrocarbons having at least six carbon atoms and mixtures thereof including refinery distillation products and by-products.

A further embodiment of the present invention relates to a printing formulation (PF VIII) comprising
(i) 0.01 wt-% to 70 wt-%, based on the total weight of the printing formulation, of monodisperse particles, chosen from the group consisting of organic polymer particles such as latex, acrylic, polystyrene, poly(vinyl acetate), polyacrylonitrile, poly(styrene-co-butadiene), polyester, polyamides, polyurethane, poly(methylmethacrylate) and poly(fluoromethylmethacrylate) particles;
   inorganic materials such as metal chalcogenide, metal pnictide, silica, metal (such as gold, copper and silver) and metal oxide particles (such as Al₂O₃, TiO₂, SnO₂, Sb₂O₅, Fe₂O₃, ZrO₂, CeO₂ and Y₂O₃), and
(ii) 0.001 wt-% to 6 wt-%, based on the total weight of the printing formulation of particles, chosen from the group consisting of organic polymer particles such as latex, acrylic, polystyrene, poly(vinyl acetate), polyacrylonitrile, poly(styrene-co-butadiene), polyester, polyamides, polyurethane, poly(methylmethacrylate) and poly(fluoromethylmethacrylate) particles;
   inorganic materials such as metal chalcogenide, metal pnictide, silica, metal (such as gold, copper and silver), metal oxide particles (such as Al₂O₃, TiO₂, SnO₂, Sb₂O₅, Fe₂O₃, ZrO₂, CeO₂ and Y₂O₃),
   as well as glass, marble, waxes (like carnuba wax), mica, calcium carbonate and talc, which have a largest dimension which is at least 6 times larger than the largest dimension of the monodisperse particles, and
(iii) 30 wt-% and 99.99 wt-%, based on the total weight of the printing formulation, of at least one solvent, chosen from the group consisting of alcohols, esters, ketones, ethers and aliphatic and aromatic hydrocarbons having at least six carbon atoms and mixtures thereof including refinery distillation products and by-products.

The printing formulation can also comprise encapsulated particles as described in WO2007/057146 and WO2006/097332.

A broad spectrum absorber contrast agent as such can also be added to the formulation.

A further embodiment of the present invention relates to a printing formulation (PF IX) comprising
(i) 0.01 wt-% to 70 wt-%, based on the total weight of the printing formulation, of encapsulated monodisperse particles, comprising
   97-99.999 wt-%, preferably 99-99.9999 wt-%, more preferably 99.5-99.9999 wt-%, based on the total weight of the encapsulated monodisperse particles, of the monodisperse particle material chosen from the group consisting of organic polymer particles such as latex, acrylic, polystyrene, poly(vinyl acetate), polyacrylonitrile, poly(styrene-co-butadiene), polyester, polyamides, polyurethane, poly(methylmethacrylate) and poly(fluoromethylmethacrylate) particles; inorganic materials such as metal chalcogenide, metal pnictide, silica, metal (such as gold, copper and silver) and metal oxide particles (such as Al₂O₃, TiO₂, SnO₂, Sb₂O₅, Fe₂O₃, ZrO₂, CeO₂ and Y₂O₃), and
   0.0001-3 wt-%, preferably 0.0001-1 wt-%, more preferably 0.0001-0.5 wt-%, based on the total weight of the encapsulated monodisperse particles, of at least one broad spectrum absorber contrast agent and/or at least one precursor of a broad spectrum absorber contrast agent chosen from the group consisting of Alizarin Blue Black, Brilliant Blue Black, carbon black, black iron oxide, iron hydroxide, iron oxide black, silver oxide black, K, Ca, Sr, Ba, Zn, Pb, Fe, Ni, Ce, Co, Cr, Cu, Mn, Sn, Al, Ag, Mg, Au, Cd, Ag nitrate, Ag halogenide, Fe nitrate and Fe halogenide, which is encapsulated,
(ii) 0.001 wt-% to 6 wt-%, based on the total weight of the printing formulation particles, wherein the particles have a largest dimension which is at least 6 times larger than the largest dimension of the monodisperse particles, and
(iiia) 30 wt-% and 99.99 wt-%, based on the total weight of the printing formulation, of water, and
(iiib) optionally 0.1 wt-% and 89.99 wt-%, based on the total weight of the printing formulation of at least one solvent, chosen from the group consisting of alcohols, esters, ketones, ethers and aliphatic and aromatic hydrocarbons having at least six carbon atoms and mixtures thereof including refinery distillation products and by-products.

A further embodiment of the present invention relates to a printing formulation (PF X) comprising
(i) 0.01 wt-% to 70 wt-%, based on the total weight of the printing formulation, of encapsulated monodisperse particles, comprising
   97-99.999 wt-%, preferably 99-99.9999 wt-%, more preferably 99.5-99.9999 wt-%, based on the total weight of the encapsulated monodisperse particles, of the monodisperse particles chosen from the group consisting of organic polymer particles such as latex, acrylic, polystyrene, poly(vinyl acetate), polyacrylonitrile, poly(styrene-co-butadiene), polyester, polyamides, polyurethane, poly(methylmethacrylate) and poly(fluoromethylmethacrylate) particles; inorganic materials such as metal chalcogenide, metal pnictide, silica, metal (such as gold, copper and silver) and metal oxide particles (such as Al₂O₃, TiO₂, SnO₂, Sb₂O₅, Fe₂O₃, ZrO₂, CeO₂ and Y₂O₃), and
   0.0001-3 wt-%, preferably 0.0001-1 wt-%, more preferably 0.0001-0.5 wt-%, based on the total weight of the encapsulated monodisperse particles, of at least one broad spectrum absorber contrast agent and/or at least one precursor of a broad spectrum absorber contrast agent chosen from the group consisting of Alizarin Blue Black, Brilliant Blue Black, carbon black, black iron oxide, iron hydroxide, iron oxide black, silver oxide black, K, Ca, Sr, Ba, Zn, Pb, Fe, Ni, Ce, Co, Cr, Cu, Mn, Sn, Al, Ag, Mg, Au, Cd, Ag nitrate, Ag halogenide, Fe nitrate and Fe halogenide, which is encapsulated,
(ii) 0.001 wt-% to 6 wt-%, based on the total weight of the printing formulation, of particles, wherein the particles have a largest dimension which is at least 6 times larger than the largest dimension of the monodisperse particles, and
(iii) 30 wt-% and 99.99 wt-%, based on the total weight of the printing formulation, of at least one solvent, chosen from the group consisting of alcohols, esters, ketones, ethers and aliphatic and aromatic hydrocarbons having at least six carbon atoms and mixtures thereof including refinery distillation products and by-products.

The monodisperse particles of printing formulations (PF VII), (PF VIII), (PF IX) and (PF X) deviate less than 10% in root mean square (rms) diameter, preferably less than 5% in rms diameter and they have a diameter from 150 nm to 900 nm, preferably from 150 nm to 800 nm, more preferably the diameter of the monodisperse particles is from about 200 nm to about 550 nm.

A further embodiment of the present invention also relates to a printing formulation (PF XI) which additionally comprises
(iv) at least one curing material, and
(v) at least one initiator.

The printing formulation (PF I), (PF II), (PF III), (PF IV), (PF V), (PF VI), (PF VII), (PF VIII), (PF IX) and (PF X) according to the present invention can also comprises at least one curing agent and at least one initiator.

Any kind of commonly known curing agents can be used.

Usually, curing agents are resins which are crosslinkable. These are low molecular or oligomeric polyfunctional compounds with a molecular mass <1000 g/mol. The functional groups which are often terminal groups (for example epoxy-, isocyanate-, amine- or hydroxy-groups) are chosen that way (amount of groups as well as kind of the groups) that they react according to the polyaddition- or polycondensation-mechanism.

The formulation according to the present invention also comprises at least one curing agent A curing agent has good mechanical, adhesive and toughness properties as well as good resistance to environmental degradation. The curing agents can be classified into two main groups the “thermoplastic” and “thermosetting” types. Any kind of commonly know curing agent can be used. Usually curing agent are resins which are crosslinkable. These are low molecular or oligomeric polyfunctional compounds with a molecular mass <1000 g/mol. The functional groups which are often terminal groups (for example epoxy-, isocyanate-, amine- or hydroxy-groups) are chose that way (amount of groups as well as kind of the groups) that the react according to the polyaddition or polycondensation mechanism

Suitable curing agents are polyester, vinylester and epoxy compounds. Furthermore phenolic, cyanate ester, polyurethane, bismaleimide, polyimide, epoxy acrylate, polyurethane acrylate, polyester acrylate, acrylated polyol and acrylated polyether compounds can be used as well.

Curing agents are well known and can be bought commercially for examples from BASF, from Jenton International UK, or from ALBERDINGK.

Such curing agents are used in an amount of 0.01 wt-%-15 wt-%, based on the total weight of the colourant composition. Preferably, curing agents are present in an amount of 0.1-10 wt-%, based on the total weight of the printing formulation.

In combination with the curing agent(s) at least one initiator is used. This initiator is which starts the polymerisation of the curing agent.

When the initiation takes place with radiation, it is usually done by exposition to light (400 nm-800 nm) and/or UV-light (100 nm-400 nm) and/or IR (800 nm-1400 nm).

Such an initiator can be peroxide or peroxide containing compounds, benzophenone and benzophenone derivatives, acetophenone and acetophenone derivatives, benzoin ether derivatives and thioxanthones derivatives.

Therefore a further preferred embodiment of the present invention relates to a printing formulation, wherein the initiator is chosen from the group consisting of peroxide or peroxide containing compounds, benzophenone and benzophenone derivatives, acetophenone and acetophenone derivatives, benzoin ether derivatives and thioxanthones derivatives.

Further suitable initiators are α-hydroxyketone, phenylglyoxylate, benzyldimethyl-ketal, α-aminoketone, mono acyl phosphine, bis acyl phosphine, phosphine oxide, metallocene, iodinum salts.

Such initiators are well known and are available for examples from BASF (Lucricin®) or Ciba Specialty Chemicals (IRGACURE® range: IRGACURE® 184, IRGACURE® 500, IRGACURE® 2959, IRGACURE® 754, IRGACURE® 651, IRGACURE® 369, IRGACURE® 907, IRGACURE® 1300, IRGACURE® 819, IRGACURE® 819DW, IRGACURE® 2022, IRGACURE® 2100, IRGACURE® 784, IRGACURE® 250 as well as the DAROCUR® range: DAROCUR® 1173, DAROCUR® MBF, DAROCUR® TPO and DAROCUR® 4265).

Such initiators are used in an amount of 0.005 wt-%-10 wt-%, based on the total weight of the printing formulation. Preferably, initiators are present in an amount of 0.01-8 wt-%, based on the total weight of the printing formulation.

A further embodiment of the present invention relates to a printing formulation (PF XII), which additionally comprises
(iv) 0.01 wt-% to 15 wt-%, based on the total weight of the printing formulation, of at least one curing material, and
(v) 0.005 wt-% to 10 wt-%, based on the total weight of the printing formulation, of at least one initiator.

A further embodiment of the present invention relates to a printing formulation (PF XIII), which additionally comprises
(iv) 0.01 wt-% to 15 wt-%, based on the total weight of the formulation, of at least one curing material chosen from the group consisting of polyester, vinylester, epoxy, phenolic, cyanate ester, polyurethane, bismaleimide, polyimide, epoxy acrylate, polyurethane acrylate, polyester acrylate, acrylated polyol and acrylated polyether compounds, and
(v) 0.005 wt-% to 10 wt-%, based on the total weight of the formulation, of at least one initiator chosen from the group consisting of peroxide or peroxide containing compounds, benzophenone and benzophenone derivatives, acetophenone and acetophenone derivatives, benzoin ether derivatives, thioxanthones derivatives α-hydroxyketone, phenylglyoxylate, benzyldimethyl-ketal, α-aminoketone, mono acyl phosphine. bis acyl phosphine, phosphine oxide, metallocene, iodinum salts.

All the preferences for the curing agent and the initiator in regard to the compounds as well as the concentrations can be applied to the printing formulations (PF I), (PF II), (PF III), (PF IV), (PF V), (PF VI), (PF VII), (PF VIII), (PF IX) and (PF X) as described above as well.

Additionally the printing formulation (formulations (PF I), (PF II), (PF III), (PF IV), (PF V), (PF VI), (PF VII), (PF VIII), (PF IX), (PF X), (PF XI), (PF XII) and (PF XIII) can comprise further auxiliaries.

Additionally a printing formulation can comprise further auxiliaries. Such auxiliaries are these commonly used in the field of printing.

Auxiliaries are those additional chemicals which are used along with the dyes, to fix the dyes to the fabric or otherwise improve our results of the printing process. Furthermore, under the term auxiliaries is to be understood the chemicals, which help to improve the property of the formulation itself, such as storage, better manipulability of the formulation, etc.

Examples of auxiliaries are for examples pigments (such as titanium dioxide or carbon black), fillers (such as barytes, calcite, mica, talc, whiting, and wollastonite), extenders, (such as aluminum silicate), degassing agents, dry flow agents, flow agents (such as polyacrylates, silicones, surfactants, and fluorinated alkyl esters), matting agents, texturing agents, rheological additives, coalescence agents and waxes.

Such auxiliaries are usually present in a smaller amount, which can go up to about 10 wt-%, based on the total weight of the printing formulation.

If one or more auxiliaries are present the amount goes usually from 0.1 wt-% to 10 wt-%.

Therefore a further embodiment of the present invention relates to a printing formulation as described above comprising additionally at least one auxiliary.

Therefore a further embodiment of the present invention relates to a printing formulation (PF XIV) additionally comprising
(vi) at least one auxiliary.

Therefore a further embodiment of the present invention relates to a printing formulation (PF XV) additionally comprising
(vi) at least one auxiliary chosen from the group consisting of pigments (such as titanium dioxide or carbon black), fillers (such as barytes, calcite, mica, talc, whiting, and wollastonite), extenders, (such as aluminum silicate), degassing agents, dry flow agents, flow agents (such as polyacrylates, silicones, surfactants, and fluorinated alkyl esters), matting agents, texturing agents, rheological additives, coalescence agents and waxes.

Another embodiment of the present invention relates to a printing formulation (PF XVI) additionally comprising
(vi) 0.1 wt-% to 10 wt-%, based on the total weight of the printing formulation, of at least one auxiliary.

Another embodiment of the present invention relates to a printing formulation (PF XVII) additionally comprising
(vi) 0.1 wt-% to 10 wt-%, based on the total weight of the printing formulation, of at least one auxiliary from the group consisting of pigments (such as titanium dioxide or carbon black), fillers (such as barytes, calcite, mica, talc, whiting, and wollastonite), extenders, (such as aluminum silicate), degassing agents, dry flow agents, flow agents (such as polyacrylates, silicones, surfactants, and fluorinated alkyl esters), matting agents, texturing agents, rheological additives, coalescence agents and waxes.

All the preferences for the curing agent and the initiator in regard to the compounds as well as the concentrations can be applied to the printing formulation (PF I), (PF II), (PF III), (PF IV), (PF V), (PF VI), (PF VII), (PF VIII), (PF IX), (PF X), (PF XI), (PF XII) and (PF XIII) as described above as well.

As already mentioned the printing formulation according to the present invention can be in any suitable physical form. Usually it is in the form of a liquid, a gel, mousse, wax or a paste.

The printing process can be done according to well known processes such as Ink jet (such as Bubble Jet, Compound jet, Dry Inkjet, Hotmelt Inkjet), rollercoating, relief printing, intaglio, letterpress, lithography, flexography, gravure, screen printing, pad printing, etc. . . .

Formulations for the inkjet technology comprising monodisperse particles are for example known from WO2005/063902

The printing formulations according to the present invention are used usually to give the product a specific visual appearance.

The printing formulations of the present invention may be applied to any suitable substrate to colour at least a region of the substrate. A structural colour effect is produced due to direct reflection and/or diffraction of light in the wavelength of visible light by the colloidal crystal. Substantially all of the light that is diffused by the colloidal crystal is absorbed by the broad spectrum absorber contrast agent. This causes an enhancement of the structural colour effect. The substrate to be coloured can have any possible form as well as size.

Preferred substrates are those with surface irregularities that act as sites for crystal nucleation.

Substrates include fibre (such as hair), skin, nails, food material, stone, ceramic, glass, paper, fabrics, wood, leather and plastics.

The object to be coated can also be a combination of various substrates and it can have any form. The printing formulations according to the present invention are very suitable to print (completely or in parts) packaging, which are for example used to sell commercial products, such as toothpaste containers, cans for drinks, shampoo container, shower gel container etc.

The printing formulations can also be used to print labels, which are then put onto a specific embodiment.

When the substrate is a food material, the printing formulation must be of a grade that can be used in food materials. Food materials in which the colourant compositions of the present invention may be used include, for example, eggs, fruit, vegetables, ice creams, sauces, water ice and chocolate.

For examples when vegetables or fruits are used, it is possible to coat the parts and/or print onto the parts which can be eaten as well as the parts, which are (usually) not eaten, like the peel, leaves, etc.

There is also provided a method of colouring the hair of an individual which method comprises the step of contacting at least a region of the hair of the individual with a printing formulation as hereinbefore defined such that a colloidal crystalline layer forms on the hair.

There is also provided a hair dye composition comprising a printing formulation as hereinbefore defined.

The hair dye compositions of the present invention may be in any suitable form. For example, the hair dye compositions may be in the form of sprays, lotions, shampoos, creams or pastes which can be applied directly to all or part of the hair. Following a suitable contact time, excess composition can then be washed off if necessary. Preferably the hair dye composition is in contact with the hair for sufficient time such that at least two or three colloidal crystalline layers are formed.

### DESCRIPTION OF THE FIGURES

FIG. 1.: SEM image of a cross section of a film (from Example 1) comprising large spherical particles, embedded within the colloidal structure.

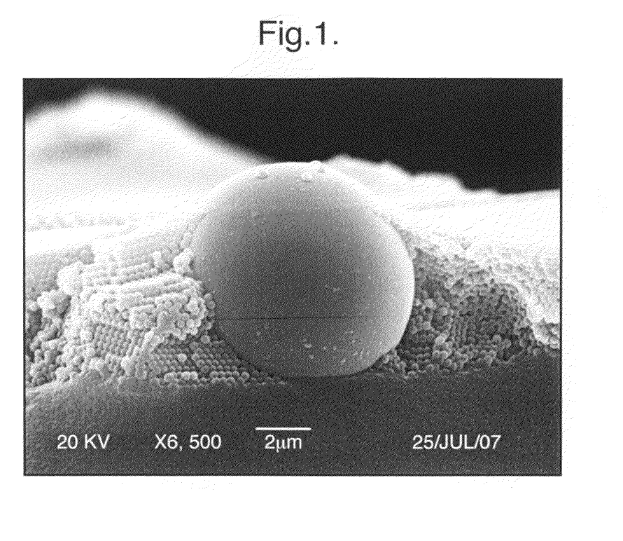

The present invention will now be described further with reference to the following non-limiting examples.

The following examples serve to illustrate the invention without limiting the invention to them.

If not otherwise stated the percentages are weight percentages and the temperatures are given in Celsius.

### EXAMPLES

### Example 1

### Silica Colloids in Overprint Varnish in Waterborne UV Resin LUX 3381 (Solvent-Free UV-Curable Polyurethane-Acrylic Dispersion from ALBERDINGK®)

| Ingredients | Amount [wt-%] |
|---|---|
| Silica powder (prep. as described above) | 55 |
| Byk 028 (surfactant) | 2.5 |
| GLASS BEADS (Spheriglass ® solid A 500 | 0.25 |
| available from Potter Glass) | |
| Irgacurec ® 500 | 1.5 |
| 2-Dimethylaminoethanol | 1.5 |
| Ethylene Glycol | 2 |
| Aquazer ® 539 | 0.5 |
| ALBERDINGK ® LUX 3381 | 2 |
| Water | 34.75 |

This water-based UV-curable polyurethane-acrylic ink composition, when applied to a substrate, especially black substrate forms a writing of iridescent metallic blue, which changes to metallic green at a far viewing angle when using colloids of 250 nm. The films are stable, after pre-drying of 5-10 min at 50 C under normal light, but more stable after exposure to efficient UV lamps, usually medium pressure mercury lamps of at least 80 W/cm. (Hg 80 W/cm), is required.

1. A printing formulation comprising
(i) monodisperse particles, and
(ii) particles, which have a largest dimension which is at least 6 times larger than the largest dimension of the monodisperse particles.

2. Printing formulation according to claim 1 comprising 0.01 up to 70 wt-%, based on the total weight of the printing formulation, of the monodisperse particles.

3. Printing formulation according to claim 1, wherein the amount of monodisperse particles lies between 30 wt-% and 70 wt-%, preferably between 30 wt-% and 60 wt-%, more preferably between 30 wt-% and 55 wt-%, based on the total weight of the printing formulation.

4. Printing formulation according to claim 1, wherein the amount of monodisperse particles lies between 0.01 wt-% and 30 wt-%, between 0.1 and 30 wt-%, more preferably between 0.1 and 20 wt-%, based on the total weight of the printing formulation.

5. Printing formulation according to claim 1, which is in liquid, gel, wax or paste form.

6. Printing formulation according to claim 1, wherein the monodisperse particles deviate less than 10% in root mean square (rms) preferably less than 5% in rms diameter.

7. Printing formulation according to claim 1, wherein the monodisperse particles are substantially spherical.

8. Printing formulation according to claim 1, wherein the monodisperse particles are inorganic.

9. Printing formulation according to claim 1, wherein the monodisperse particles are organic polymers.

10. Printing formulation according to claim 8, wherein the monodisperse particles are made from organic polymer particles chosen from the group consisting of latex, acrylic, polystyrene, poly(vinyl acetate), polyacrylonitrile, poly(styrene-co-butadiene), polyester, polyamides, polyurethane, poly(methylmethacrylate) and poly(fluoromethylmethacrylate) particles.

11. Printing formulation according to claim 9, wherein the monodisperse particles are made from inorganic materials chosen from the group consisting of chalcogenide, metal pnictide, silica, metal and metal oxide particles.

12. Printing formulation according to claim 1, wherein the particles have a largest dimension which is at least 6 times up to 100 times larger than the largest dimension of the monodisperse particles.

13. Printing formulation according to claim 1, wherein the particles have a largest dimension which is at least 10 times larger than the largest dimension of the monodisperse particles.

14. Printing formulation according to claim 1, wherein the particles from organic polymer particles chosen from the group consisting of latex, acrylic, polystyrene, poly(vinyl acetate), polyacrylonitrile, poly(styrene-co-butadiene), polyester, polyamides, polyurethane, poly(methylmethacrylate) and poly(fluoromethylmethacrylate) particles; from inorganic materials chosen from the group consisting of chalcogenide, metal pnictide, silica, metal, metal oxide particles as well as from glass, marble, waxes (like carnuba wax), mica, calcium carbonate and talc.

15. Printing formulation according to claim 1 comprising 0.001-6 wt-%, based on the total weight of the printing formulation, of the particles.

16. Printing formulation according to claim 1 comprising at least one solvent.

17. Printing formulation according to claim 16, wherein the solvent is chosen from the group consisting of water, alcohols (mono or poly), esters, ketones and ethers, aliphatic and aromatic hydrocarbons having at least six carbon atoms and mixtures thereof including refinery distillation products and by-products.

18. Printing formulation according to claim 1 which is an aqueous or a nonaqueous formulation.

19. Printing formulation according to claim 1, comprising 10 wt-% to about 99.99 wt-%, preferably from about 20 wt-% to about 99.9 wt-%, and more preferably from about 30 wt-% to about 99.9 wt-%, based on total weight of the printing formulation, of at least one solvent.

20. Printing formulation according to claim 1 comprising
at least one curing material, and
at least one initiator.

21. Printing formulation according to claim 20, wherein the curing agent is chosen from the group consisting polyester, vinylester, epoxy, phenolic, cyanate ester, polyurethane, bismaleimide, polyimide, epoxy acrylate, polyurethane acrylate, polyester acrylate, acrylated polyol and acrylated polyether compounds.

22. Printing formulation according to claim 1 comprising 0.01 wt-%-15 wt-%, based on the total weight of the printing formulation, of at least one curing agent.

23. Printing formulation according to claim 20, wherein the initiator is chosen from the group consisting of peroxide or peroxide containing compounds, benzophenone and benzophenone derivatives, acetophenone and acetophenone derivatives, benzoin ether derivatives, thioxanthones derivatives, □-hydroxyketone, phenylglyoxylate, benzyldimethyl-ketal, □-aminoketone, mono acyl phosphine, bis acyl phosphine, phosphine oxide, metallocene and iodinum salts.

24. Printing formulation according to claim 1 comprising 0.005 wt-%-10 wt-%, preferably 0.01-8 wt-%, based on the total weight of the printing formulation, of at least one initiator.

25. Printing formulation according to claim 1 comprising at least one auxiliary.

26. Printing formulation according to claim 25, wherein the auxiliary are chosen from the group consisting of pigments (such as titanium dioxide or carbon black), fillers (such as barytes, calcite, mica, talc, whiting, and wollastonite), extenders, (such as aluminum silicate), degassing agents, dry flow agents, flow agents (such as polyacrylates, silicones, surfactants, and fluorinated alkyl esters), matting agents, texturing agents, rheological additives, coalescence agents and waxes.

27. Printing formulation according to claim 25 comprising 0.1 wt-% to 10 wt-%, based on the total weight of the printing formulation, of at least one auxiliary.

28. Use of a printing formulation according to claim 1 for printing on a substrate.

29. Use according to claim 28, wherein the substrate can be chosen from the group consisting of fibre (such as hair), skin, nails, food material, stone, ceramic, glass, paper, fabrics, wood, leather and plastics.

30. Substrate printed by at least one formulation according to claim 1.

31. Substrate according to claim 30, wherein the substrate is chosen from the group consisting of fibre (such as hair), skin, nails, food material, stone, ceramic, glass, paper, fabrics, wood, leather and plastics.
